(19) United States
(12) Patent Application Publication
(10) Pub. No.: US 2024/0323865 A1
(43) Pub. Date: Sep. 26, 2024

(54) BEAM-SPECIFIC METRICS IN REPORTS FOR UL TRANSMISSION

(71) Applicant: QUALCOMM Incorporated, San Diego, CA (US)

(72) Inventors: Fang YUAN, Beijing (CN); Yan ZHOU, San Diego, CA (US); Qiaoyu LI, Beijing (CN); Tao LUO, San Diego, CA (US)

(21) Appl. No.: 18/578,702

(22) PCT Filed: Aug. 25, 2021
(86) PCT No.: PCT/CN2021/114440

§ 371 Date: Jan. 11, 2024

(51) Int. Cl. H04W 52/36; H04B 7/06; H04W 52/24

(52) U.S. Cl. CPC H04W 52/365; H04B 7/0626; H04W 52/242

(57) ABSTRACT

Methods, apparatuses, and computer-readable medium are provided to facilitate beam specific UL metrics reporting. An example method includes transmitting, to a base station, an UL report associated with a PL RS or one or more beam-specific PC parameters associated with one or more candidate SSBRIs or one or more CRIs associated with a candidate pool; the UL report including one or more of: a virtual PHR report associated with each of the one or more candidate SSBRIs or the one or more candidate CRIs, or a L1 CSI report including one or more UL metrics. The example method may further include communicating with the base station based on the UL report.

### TECHNICAL FIELD

The present disclosure relates generally to communication systems, and more particularly, to wireless communication systems with uplink (UL) report.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include a memory and at least one processor coupled to the memory. The memory and the at least one processor coupled to the memory may be configured to transmit, to a base station, an uplink (UL) report associated with a pathloss (PL) reference signal (RS) or one or more beam-specific power control (PC) parameters associated with one or more candidate synchronization signal block (SSB) resource indicators (SSBRIs) or one or more channel state information (CSI) RS resource indicators (CRIs) associated with a candidate pool. The UL report may include one or more of: a virtual power headroom (PHR) report associated with each of the one or more candidate SSBRIs or the one or more candidate CRIs, or a layer 1 (L1) channel state information (CSI) report including one or more UL metrics.

The memory and the at least one processor coupled to the memory may be further configured to communicate with the base station based on the UL report.

In another aspect of the disclosure, a method, a computer-readable medium, and an apparatus are provided. The apparatus may include a memory and at least one processor coupled to the memory. The memory and the at least one processor coupled to the memory may be configured to receive, from a UE, an UL report associated with a PL RS or one or more beam-specific PC parameters associated with one or more candidate SSBRIs or one or more CRIs associated with a candidate pool. The UL report may include one or more of: a virtual PHR report associated with each of the one or more candidate SSBRIs or the one or more candidate CRIs, or a L1 CSI report including one or more UL metrics. The memory and the at least one processor coupled to the memory may be further configured to communicate with the UE based on the uplink report.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating a base station in communication with a UE via a set of beams.

FIG. 5 is a diagram illustrating a data field for reporting maximum permissible exposure (MPE).

FIG. 6 is a diagram illustrating communications between a UE and a base station.

FIG. 7 is a flowchart of a method of wireless communication.

FIG. 8 is a flowchart of a method of wireless communication.

FIG. 9 is a diagram illustrating an example of a hardware implementation for an example apparatus.

FIG. 10 is a diagram illustrating an example of a hardware implementation for an example apparatus.

### DETAILED DESCRIPTION

A TCI state may include information that a UE may use to derive timing/frequency error and/or transmission/reception spatial filtering for transmitting/receiving a signal. A base station may indicate a TCI state to the UE as a transmission configuration that indicates relationships between one signal (e.g., a reference signal) and the signal to be transmitted/received. TCI states may provide information about different beam selections for the UE to use for transmitting/receiving various signals.

In some wireless communication systems, such as a wireless communication system under a unified TCI framework, a pool of joint DL/UL TCI states may be used for joint DL/UL TCI state updates for beam indication. The TCI state pool for separate DL and UL TCI state updates may be used. In some aspects, the joint TCI may or may not include UL-specific parameter(s) such as UL PC/timing parameters, PL RS, panel-related indication, or the like. If the joint TCI includes the UL-specific parameter(s), the parameters may be used for the UL transmission of the DL and UL transmissions to which the joint TCI is applied.

Example aspects provided herein may support beam-specific UL reporting in various UL reports, such as virtual PHR or CSI RS reports. The beam-specific UL reporting may include beam-specific power control (PC) parameters for calculating UL metrics.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

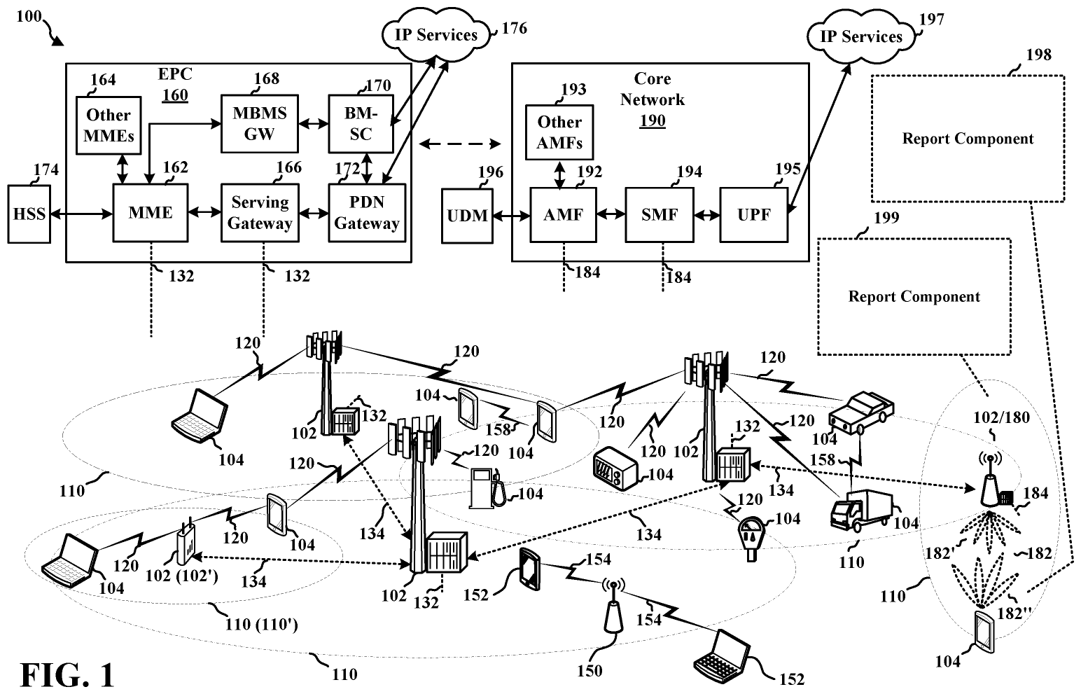

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHZ spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a report component 198. In some aspects, the report component 198 may be configured to transmit, to a base station, an UL report associated with a PL RS or one or more beam-specific PC parameters associated with one or more candidate SSBRIs or one or more CRIs associated with a candidate pool. The UL report may include one or more of: a virtual PHR report associated with each of the one or more candidate SSBRIs or the one or more candidate CRIs, or a L1 CSI report including one or more UL metrics. In some aspects, the report component 198 may be further configured to communicate with the base station based on the uplink report.

In certain aspects, the base station 180 may include a report component 199. In some aspects, the report component 199 may be configured to receive, from a UE, an UL report associated with a PL RS or one or more beam-specific PC parameters associated with one or more candidate SSBRIs or one or more CRIs associated with a candidate pool. The UL report may include one or more of: a virtual PHR report associated with each of the one or more candidate SSBRIs or the one or more candidate CRIs, or a L1 CSI report including one or more UL metrics. In some aspects, the report component 199 may be further configured to communicate with the UE based on the uplink report.

Although the following description may be focused on 5G NR, the concepts described herein may be applicable to other similar areas, such as LTE, LTE-A, CDMA, GSM, and other wireless technologies.

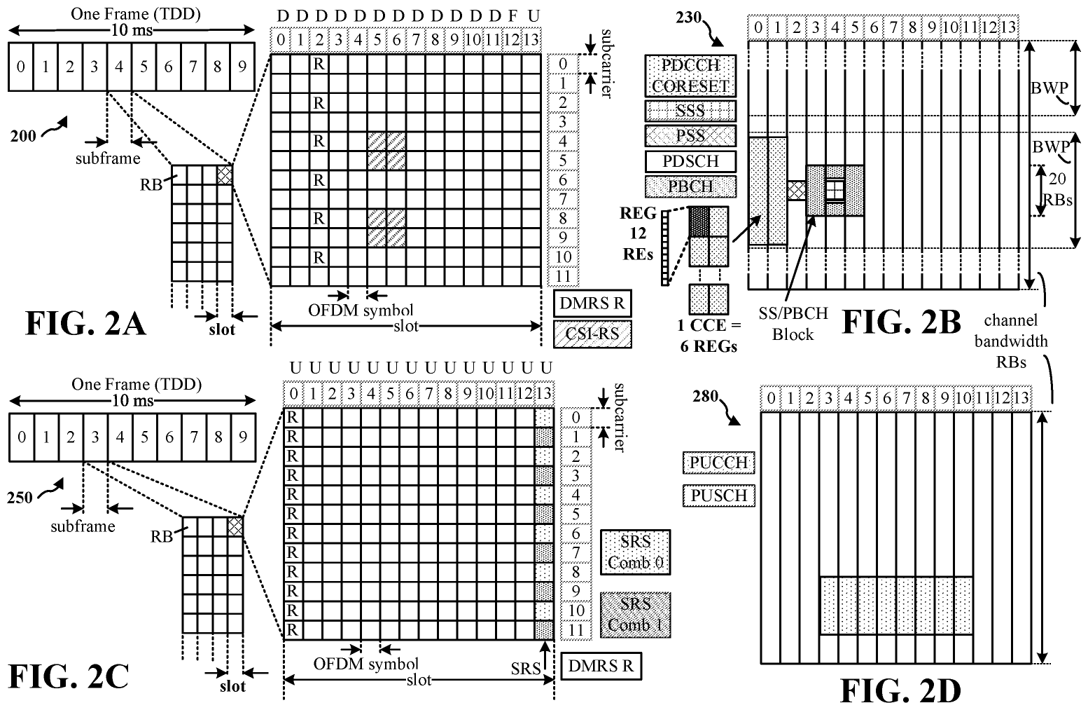

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

TABLE 1

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

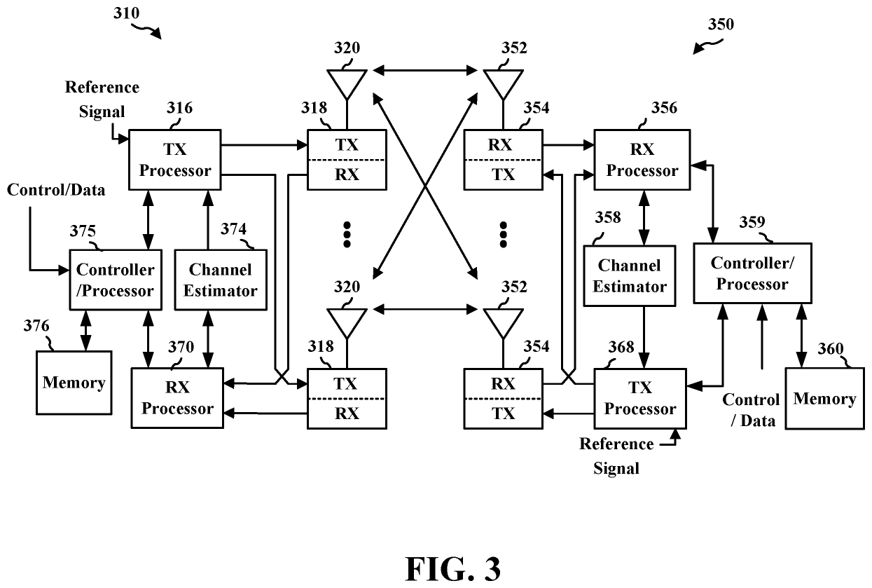

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with report component 198 of FIG. 1.

At least one of the TX processor 316, the RX processor 370, and the controller/processor 375 may be configured to perform aspects in connection with report component 199 of FIG. 1.

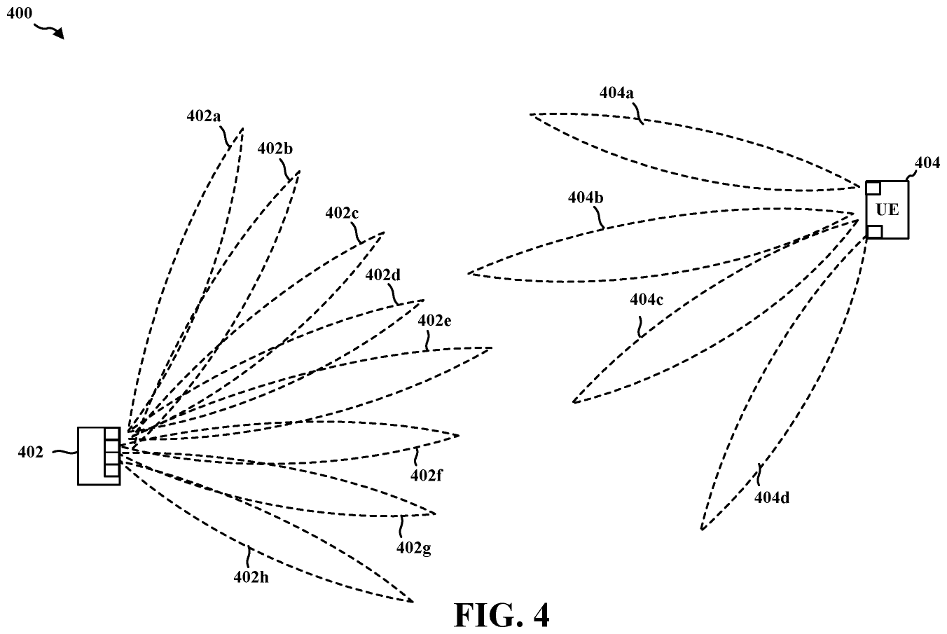

FIG. 4 is a diagram 400 illustrating a base station 402 in communication with a UE 404. Referring to FIG. 4, the base station 402 may transmit a beamformed signal to the UE 404 in one or more of the directions 402a, 402b, 402c, 402d, 402c, 402f, 402g, 402h. The UE 404 may receive the beamformed signal from the base station 402 in one or more receive directions 404a, 404b, 404c, 404d. The UE 404 may also transmit a beamformed signal to the base station 402 in one or more of the directions 404a-404d. The base station 402 may receive the beamformed signal from the UE 404 in one or more of the receive directions 402a-402h. The base station 402/UE 404 may perform beam training to determine the best receive and transmit directions for each of the base station 402/UE 404. The transmit and receive directions for the base station 402 may or may not be the same. The transmit and receive directions for the UE 404 may or may not be the same. The term beam may be otherwise referred to as “spatial filter”. Beamforming may be otherwise referred to as “spatial filtering”.

In response to different conditions, the UE 404 may determine to switch beams, e.g., between beams 402a-402h. The beam at the UE 404 may be used for reception of downlink communication and/or transmission of uplink communication. In some examples, the base station 402 may send a transmission that triggers a beam switch by the UE 404. A TCI state may include Quasi co-location (QCL) information that the UE can use to derive timing/frequency error and/or transmission/reception spatial filtering for transmitting/receiving a signal. Two antenna ports are said to be quasi co-located if properties of the channel over which a symbol on one antenna port is conveyed can be inferred from the channel over which a symbol on the other antenna port is conveyed. The base station may indicate a TCI state to the UE as a transmission configuration that indicates QCL relationships between one signal (e.g., a reference signal) and the signal to be transmitted/received. For example, a TCI state may indicate a QCL relationship between DL RSs in one RS set and PDSCH/PDCCH DM-RS ports. TCI states can provide information about different beam selections for the UE to use for transmitting/receiving various signals. For example, the base station 402 may indicate a TCI state change, and in response, the UE 404 may switch to a new beam according to the new TCI state indicated by the base station 402.

In some wireless communication systems, such as a wireless communication system under a unified TCI framework, a pool of joint DL/UL TCI states may be used for joint DL/UL TCI state updates for beam indication. For example, the base station 402 may transmit a pool of joint DL/UL TCI states to the UE 404. The UE 404 may determine to switch transmission beams and/or reception beams based on the joint DL/UL TCI states. In some aspects, the TCI state pool for separate DL and UL TCI state updates may be used. In some aspects, the base station 402 may use RRC signaling to configure the TCI state pool. In some aspects, the joint TCI may or may not include UL-specific parameter(s) such as UL PC/timing parameters, PL RS, panel-related indication, or the like. If the joint TCI includes the UL-specific parameter(s), the parameters may be used for the UL transmission of the DL and UL transmissions to which the joint TCI is applied.

Under a unified TCI framework, different types of common TCI states may be indicated. For example, a type 1 TCI may be a joint DL/UL common TCI state to indicate a common beam for at least one DL channel or RS and at least one UL channel or RS. A type 2 TCI may be a separate DL (e.g., separate from UL) common TCI state to indicate a common beam for more than one DL channel or RS. A type 3 TCI may be a separate UL common TCI state to indicate a common beam for more than one UL channel/RS. A type 4 TCI may be a separate DL single channel or RS TCI state to indicate a beam for a single DL channel or RS. A type 5 TCI may be a separate UL single channel or RS TCI state to indicate a beam for a single UL channel or RS. A type 6 TCI may include UL spatial relation information (e.g., such as sounding reference signal (SRS) resource indicator (SRI)) to indicate a beam for a single UL channel or RS. An example RS may be an SSB, a tracking reference signal (TRS) and associated CSI-RS for tracking, a CSI-RS for beam management, a CSI-RS for CQI management, a DM-RS associated with non-UE-dedicated reception on PDSCH and a subset (which may be a full set) of control resource sets (CORESETs), or the like.

A TCI state may be defined to represent at least one source RS to provide a reference (e.g., UE assumption) for determining quasi-co-location (QCL) or spatial filters. For example, a TCI state may define a QCL assumption between a source RS and a target RS.

To accommodate situations where beam indication for UL and DL are separate, two separate TCI states (one for DL and another one for UL) may be utilized. For a separate DL TCI, the source reference signal(s) in M (M being an integer) TCIs may provide QCL information at least for UE-dedicated reception on PDSCH and for UE-dedicated reception on all or subset of CORESETs in a CC. For a separate UL TCI, the source reference signal(s) in N (N being an integer) TCIs provide a reference for determining common UL transmission (TX) spatial filter(s) at least for dynamic-grant or configured-grant based PUSCH and all or subset of dedicated PUCCH resources in a CC.

In some aspects, the UL TX spatial filter may also apply to all SRS resources in resource set(s) configured for antenna switching, codebook-based, or non-codebook-based UL transmissions.

In some aspects, each of the following DL RSs may share the same indicate TCI state as UE-dedicated reception on PDSCH and for UE-dedicated reception on all or subset of CORESETs in a CC: CSI-RS resources for CSI, some or all CSI-RS resources for beam management, CSI-RS for tracking, and DM-RS(s) associated with UE-dedicated reception on PDSCH and all/subset of CORESETs. Some SRS resources or resource sets for beam management may share the same indicated TCI state as dynamic-grant/configured-grant based PUSCH, all or subset of dedicated PUCCH resources in a CC. In some wireless communication systems, several QCL rules may be defined. For example, a first rule may define that TCI to DM-RS of UE dedicated PDSCH and PDCCH may not have SSB as a source RS to provide QCL type D information. A second rule may define that TCI to some DL RS such as CSI-RS may have SSB as a source RS to provide QCL type D information. A third rule may define that TCI to some UL RS such as SRS can have SSB as a source RS to provide spatial filter information. Example aspects provided herein enable a UE to signal capability of applying unified TCI to RS, provide QCL indication to DL RS, and provide hybrid spatial filter indication to UL RS.

In some wireless communication systems, to facilitate a common TCI state ID update and activation to provide common QCL information at least for UE-dedicated PDCCH/PDSCH (e.g., common to UE-dedicated PDCCH and UE-dedicated PDSCH) or common UL TX spatial filter(s) at least for UE-dedicated PUSCH/PUCCH across a set of configured CCs/BWPs (e.g., common to multiple PUSCH/PUCCH across configured CCs/BWPs), several configurations may be provided. For example, the RRC-configured TCI state pool(s) may be configured as part of the PDSCH configuration (such as in a PDSCH-Config parameter) for each BWP or CC. The RRC-configured TCI state pool(s) may be absent in the PDSCH configuration for each BWP/CC, and may be replaced by a reference to RRC-configured TCI state pool(s) in a reference BWP/CC. For a BWP/CC where the PDSCH configuration contains a reference to the RRC-configured TCI state pool(s) in a reference BWP/CC, the UE may apply the RRC-configured TCI state pool(s) in the reference BWP/CC. When the BWP/CC identifier (ID) (e.g., for a cell) for QCL-Type A or Type D source RS in a QCL information (such as in a QCL info parameter) of the TCI state is absent, the UE may assume that QCL-Type A or Type D source RS is in the BWP/CC to which the TCI state applies. In addition, a UE may report a UE capability indicating a maximum number of TCI state pools that the UE can support across BWPs and CCs in a band.

Before receiving a TCI state, a UE may assume that the antenna ports of one DM-RS port group of a PDSCH are spatially QCL′d with an SSB determined in the initial access procedure with respect to one or more of: a Doppler shift, a Doppler spread, an average delay, a delay spread, a set of spatial Rx parameters, or the like. After receiving the new TCI state, the UE may assume that the antenna ports of one DM-RS port group of a PDSCH of a serving cell are QCL′d with the RS(s) in the RS set with respect to the QCL type parameter(s) given by the indicated TCI state. Regarding the QCL types, QCL type A may include the Doppler shift, the Doppler spread, the average delay, and the delay spread; QCL type B may include the Doppler shift and the Doppler spread; QCL type C may include the Doppler shift and the average delay; and QCL type D may include the spatial Rx parameters (e.g., associated with beam information such as beamforming properties for finding a beam). In some aspects, the maximum number of TCI states may be 128.

In some aspects, a UE may receive a signal from a base station. The signal may be configured to trigger a TCI state change and may be received via, for example, a medium access control (MAC) control element (CE) (MAC-CE), a downlink control information (DCI), or a radio resource control (RRC) signal. The TCI state change may cause the UE to find the best or most suitable UE receive beam corresponding to the TCI state indicated by the base station and switch to such beam. Switching beams may allow for an enhanced or improved connection between the UE and the base station by ensuring that the transmitter and receiver use the same configured set of beams for communication.

In some aspects, a spatial relation change, such as a spatial relation update, may trigger the UE to switch beams. Beamforming may be applied to uplink channels, such as a PUSCH, a PUCCH, or an SRS. Beamforming may be based on configuring one or more spatial relations between the uplink and downlink signals. Spatial relation indicates that a UE may transmit the uplink signal using the same beam used for receiving the corresponding downlink signal.

In another aspect, the base station 402 may indicate a change in a PL RS that the UE may use to determine power control for uplink transmissions, such as a PUSCH, a PUCCH, or an SRS. In response to the change in the PL RS, the UE 404 may determine to switch to a new beam.

Some wireless communication systems may use codebook-based MIMO. MIMO systems may allow multiple independent radio terminals, each of which has one or multiple antennas that communicate with a given access point in such a way that each radio terminal can fully utilize all the spectral resources simultaneously. A MIMO system (such as the base station 402) may employ a procedure, such as precoding, to resolve the problem of interference among the signals transmitted from an access point to the multiple terminals in the same frequency band at the same time.

In codebook-based MIMO wireless communication systems, the precoding may be selected from a standardized codebook. In a non-codebook-based MIMO, there may be no such codebook, and the precoding may be dynamically determined. For some non-codebook-based MIMO in a PUSCH, an SRI field in DCI may indicate a set of precoders associated with an SRS resource set and a set of power control (PC) parameters which may include P0, alpha, closed-loop index (which may be referred to as “Closedloopindex”), PL RS, or the like. P0 may represent a base station received power per resource block assuming a path loss of 0 decibels (dB). Alpha may represent possible values for uplink power control (e.g., pathloss compensation factor). The closed-loop index may be an index of the closed power control loop associated with the SRI and the associated PUSCH. A beam of the PUSCH may follow the SRS resource set. For example, all SRSs in the same SRS resource set may have the same beam, and the SRI may not select a beam.

For some codebook-based MIMO in a PUSCH, an SRI field in DCI may select an SRS resource from multiple SRSs in an SRS resource set for determining a beam for PUSCH transmission. For example, different SRS selected by SRI in the SRS resource set may have different beams. A transmitted precoding matrix indicator (TPMI) in DCI may indicate precoders, and the SRI field may indicate a set of power control parameters which may also include P0, alpha, Closedloopindex, PL RS, or the like.

For PC parameters that are not PL RS (e.g., P0, alpha, and closedloopindex), for each of PUSCH, PUCCH, and SRS, one or more of the following settings may be selected or combined: 1) the setting of (P0, alpha, closed-loop index) may be associated with UL or (if applicable) joint TCI state; 2) the setting of (P0, alpha, closed-loop index) may be included with UL or (if applicable) joint TCI state; and 3) the setting of (P0, alpha, closed-loop index) may be neither associated with nor included in UL or (if applicable) joint TCI state. The setting of (P0, alpha, closed-loop index) may be associated with the UL channel or UL RS. Therefore, the setting of PC parameters that are not PL RS may be channel-specific and signal-specific. PL RS settings may be configured differently. For example, PL RS may be included in UL TCI state (or, if applicable, joint TCI state). If not included in the UL TCI state, PL RS may be the periodic DL-RS used as a source RS for determining spatial TX filter or the PL RS used for the UL RS in UL or (if applicable) joint TCI state. PL-RS may also be associated with (but not included in) UL TCI state (or, if applicable, joint TCI state). If not associated with the UL TCI state, PL RS may be the periodic DL-RS used as a source RS for determining spatial TX filter or the PL RS used for the UL RS in UL or (if applicable) joint TCI state. A UE may also calculate path-loss based on periodic DL RS configured as the source RS for determining spatial TX filter in UL or (if applicable) joint TCI state. In some aspects, if a PL RS is not included in or associated with the UL TCI state (or, if applicable, joint TCI state), the UE may estimate path-loss based on the PL-RS of an UL RS provided in an UL TCI state (or, if applicable, joint TCI state) as a source RS for determining the spatial TX filter. In some aspects, if a PL RS is not included in or associated with the UL TCI state (or, if applicable, joint TCI state), the UE may not estimate path-loss based on the PL-RS of an UL RS provided in an UL TCI state (or, if applicable, joint TCI state) as a source RS for determining the spatial TX filter. In some aspects, a UE may calculate path-loss based on periodic DL RS configured as the source RS or a periodic QCL-Type-D/spatialRelationInfo source of the source RS in UL TCI state or (if applicable) joint TCI state.

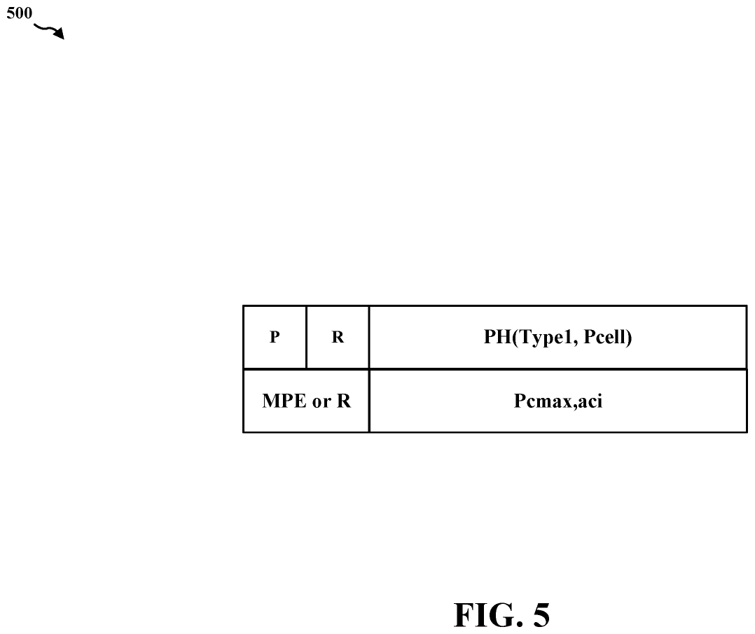

FIG. 5 is a diagram 500 illustrating a data field (which may be in a medium access control control element (MAC-CE) for reporting maximum permissible exposure (MPE). As illustrated in FIG. 5, the data field may include one or more reserved bits R. The data field may include power headroom (PH) that indicates a power headroom level. P may indicate whether the MAC entity may apply power backoff due to power management. If a parameter mpe-Reporting is configured (representing whether the UE may report MPE), P may be set to 0 if a power backoff is less than a configured threshold, and P may be set to 1 if the power backoff is not less than the configured threshold. The MAC entity may set the P field to 1 if the corresponding P_{CMAX,f,c} field may have a different value if no power backoff due to power management had been applied. The P_{CMAX,f,c} field may represent a configured maximum UE output power for a serving cell and may be used for calculation of the preceding PH field. The MPE field may represent the applied power backoff to meet MPE requirements if the mpe-Reporting parameter is configured and if the P field is set to 1. The MPE field may otherwise represent an index of the corresponding measured values of P-MPR levels in decibel (dB) if the mpe-Reporting parameter is not configured or if the P field is set to 0.

In some wireless communication systems, a UE may determine that a Type 1 PHR report for an activated serving cell is based on an actual PUSCH transmission and may compute the Type 1 PHR report accordingly. In some aspects, a UE may determine that a Type 3 power headroom report for an activated serving cell is based on an actual SRS transmission and may compute the Type 3 PHR report accordingly.

In some wireless communication systems, several options may be provided for reporting UL metrics. For example, in a first option, a P-MPR based beam/panel level report may be associated with a virtual PHR report. The virtual PHR report may be associated with each activated UL TCI or, if applicable, joint TCI, or associated with each of the reported SSBRI(s)/CRI(s) and/or panel indication (if configured) from candidate pool, if reported. The report may be based on event-driven mechanisms. In a second option, SSBRI(s)/CRI(s) and/or panel indication may be associated with L1 reference signal received power (RSRP) or signal to interference or noise ratio (SINR) may account for MPE associated with each of the reported SSBRI(s)/CRI(s) and/or panel indication (if configured).

In some wireless communication systems, such as a wireless communication system under a unified TCI framework, a pool of joint DL/UL TCI states may be used for joint DL/UL TCI state updates for beam indication. The TCI state pool for separate DL and UL TCI state updates may be used. In some aspects, the joint TCI may or may not include UL-specific parameter(s) such as UL PC/timing parameters, PL RS, panel-related indication, or the like. If the joint TCI includes the UL-specific parameter(s), the parameters may be used for the UL transmission of the DL and UL transmissions to which the joint TCI is applied.

Example aspects provided herein may support beam-specific UL reporting in various UL reports, such as virtual PHR or CSI RS reports. The beam-specific UL reporting may include beam-specific power control (PC) parameters for calculating UL metrics.

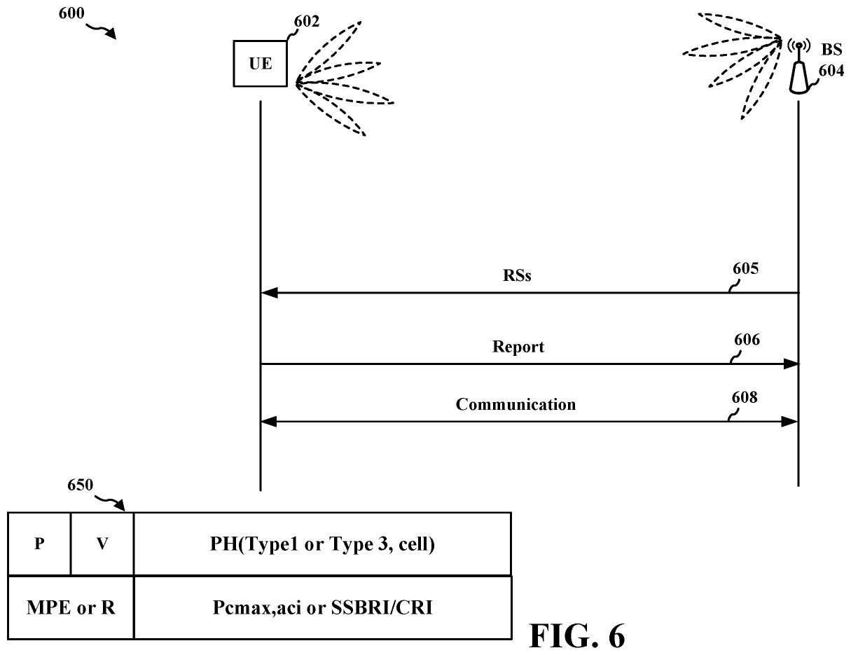

FIG. 6 is a diagram 600 illustrating example communications via one or more beams between a UE 602 and a base station 604. As illustrated in FIG. 6, the UE 602 may generate one or more reports 606 based on one or more received RSs 605 and may transmit the one or more reports 606 to the base station 604, and may exchange communication 608 with the base station 604 accordingly. The one or more reports 606 may include L1 CSI RS reports, virtual PHR reports, or the like.

In some aspects, a virtual PHR report in the one or more reports 606 may be associated with each of the reported SSBRI(s)/CRI(s) from a candidate pool (if reported). In some aspects, the candidate pool may be configured via radio resource control (RRC) by the base station 604. In some aspects, the candidate pool may be derived from other RS sets, such as an RS in the one or more RSs 605. For example, SSB resource set, TCI activated state sets, or activated PLRS sets may be used to derive the candidate pool. In some aspects, the UE 602 may report a virtual PH value by assuming beam-specific PC parameters (PL RS, P0, closed-loop index, alpha) associated with the SSBRI/CRI. In some aspects, the UE 602 may report an actual beam-specific MPE (or P-MPR) value associated with SSBRI/CRI. As illustrated in a data field 650 for reporting PHR, the data field V may represent if the PH value is based on a real transmission or a reference format. For example, if V=0, a real PH value, an MPE value and a Pcmax value may be reported based on an indicated unified TCI. If V=1, a virtual PH value, an MPE value and an SSBRI/CRI value may be reported based on a reported RS or unified TCI.

In some aspects, an L1 CSI-RS report may be included in the one or more reports 606 for UL reporting, such as candidate MPE measurement or UL RSRP. In some aspects, the UE 602 may report a number of K resource indices (i.e., indices for RSs such as SSB or CSI-RS resource), and a number of K UL metrics (i.e., modified virtual PHR, UL-RSRP), in a CSI report instance, K being a positive integer. In some aspects, the UL metrics and the resource indices in the CSI report may be one-to-one mapped. For example, the UE 602 may report one candidate RS index, one UL metric or one DL metric, or one UL metric. As one example, the UE 602 may report a CRI and virtual power headroom for a reported RS, or the UE 602 may report a CRI, a DL L1-RSRP, and virtual power headroom for a reported RS. The virtual power headroom may be calculated based on beam-specific PC parameters (i.e., any of PLRS, Po, closed loop index and alpha) and beam-specific MPE value. In some aspects, the UE 602 may report its UE capability for the maximum value of K. In some aspects, the number of K may be configured in the RRC signaling for the CSI report configuration. In some aspects, the UL metrics, if it is for modified virtual PHRs, may be for Type 1 or 3 PHR report, based on configurations. In some aspects, the CSI report may be configured as aperiodic CSI report, semi-persistent CSI report, or periodical CSI report. In some aspects, the CSI report may be carried in PUCCH or PUSCH.

In some aspects, a PL RS may be associated with the candidate SSBRI/CRI in UL reporting associated with the one or more reports 606. In some aspects, the UE 602 may use the measured SSB/CSI-RS itself as PL RS to calculate the PHR value. In some aspects, the UE 602 may use a default PL RS to calculate the PHR value, e.g. SSB for reading the master information block (MIB). In some aspects, the SSBRI/CRI may be associated with a unified TCI (joint TCI or UL TCI), and the PL RS associated with or included in the TCI may be used to calculate the PHR value. In some aspects, the UE 602 may use a PL RS based on a combination of the previously described aspects based on one or more conditions. For example, if the candidate RS has no TCI associated, the UE 602 may use the measured SSB/CSI-RS or the default PL RS as the PL RS to calculate the PHR value. If the candidate RS has associated TCI, the UE 602 may use the PL RS associated with or included in the TCI to calculate the PHR value. When the UE 602 reports a UL metric such as virtual power headroom value based on a PL RS, the pathloss to be calculated in the virtual power headroom may be based on the L1-RSRP value measured from the mapped SSB/CSI-RS or unified TCI. The L1-RSRP value may be measured with at least once by the UE 602.

In some aspects, one or more PC parameters (P0, alpha, closed-loop index) may be associated with the candidate SSBRI/CRI in UL reporting associated with the one or more reports 606. In some aspects, the UE 602 may use a default or a fixed set of PC parameters. In some aspects, the UE 602 may use a default PC parameter associated with the default PL RS to calculate the PHR value, e.g. SSB for reading the MIB. In some aspects, the UE 602 may use the set of PC parameters included in or associated with a unified TCI that is related to the SSBRI/CRI to calculate the PHR value. In some aspects, the UE 602 may use a set of PC parameters based on one or more conditions. For example, if the candidate RS has no TCI associated, the UE 602 may use the default, the fixed set of PC parameters, or the default PC parameter associated with the default PL RS to calculate the PHR value. Otherwise, the UE may use the set of PC parameters included in or associated with a unified TCI that is related to the SSBRI/CRI to calculate the PHR value.

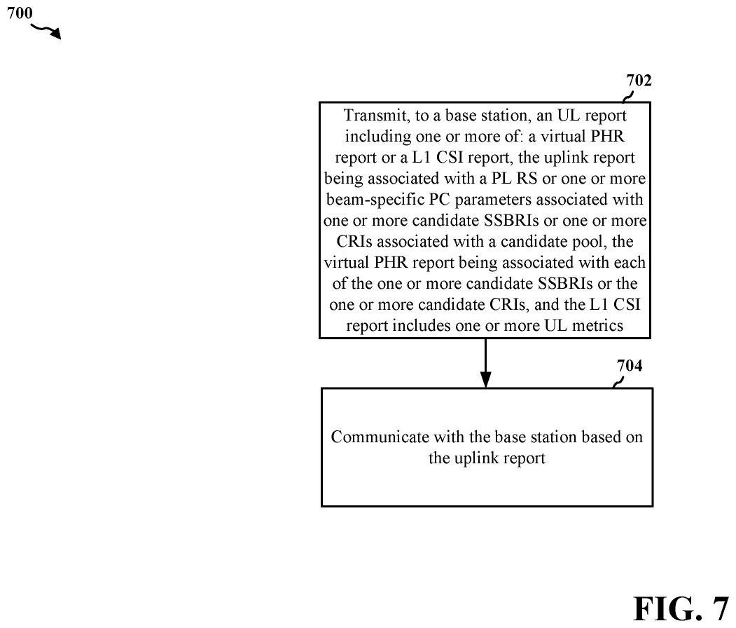

FIG. 7 is a flowchart 700 of a method of wireless communication. The method may be performed by a UE (e.g., the UE 104, the UE 404, the UE 602; the apparatus 902). The method may be used for beam-specific UL reporting that may improve efficiency of wireless communication.

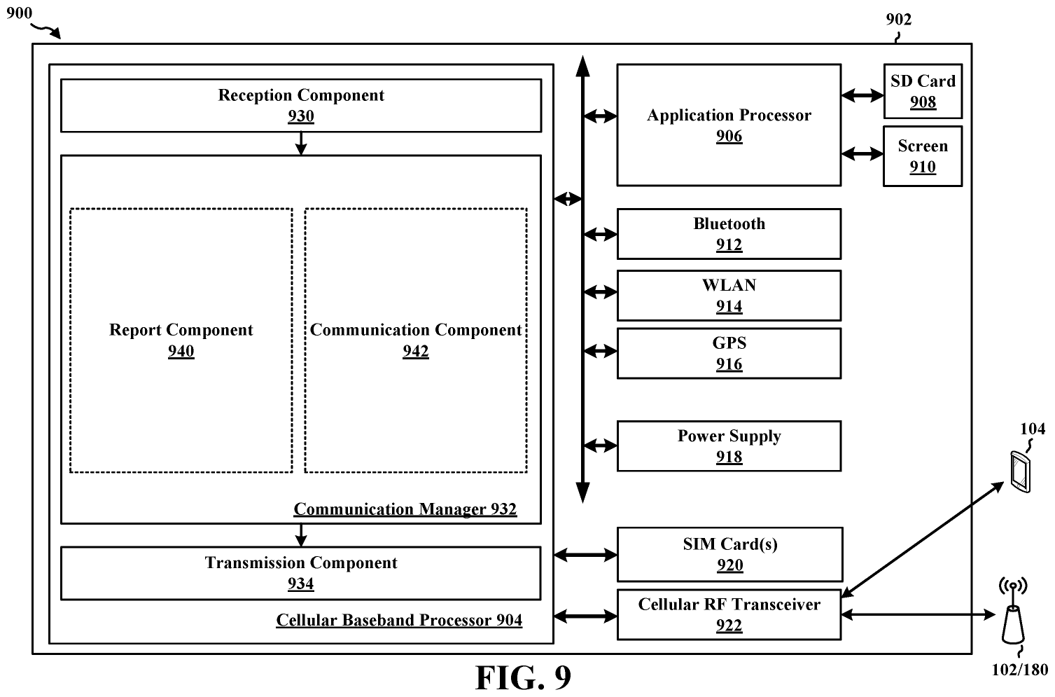

At 702, the UE may transmit, to a base station, an UL report. The UL report may include one or more of: a virtual PHR report or a L1 CSI report. The uplink report may be associated with a PL RS or one or more PC parameters associated with one or more candidate SSBRIs or one or more CRIs associated with a candidate pool. The virtual PHR report may be associated with each of the one or more candidate SSBRIs or the one or more candidate CRIs, and the L1 CSI report may include one or more UL metrics. For example, the UE 602 may transmit, to a base station 604, an UL report 606 including one or more of: a virtual PHR report or a L1 CSI report. In some aspects, 702 may be performed by the report component 940 of FIG. 9. In some aspects, the UL report includes the virtual PHR report based on the candidate pool is configured via RRC. In some aspects, the one or more RS sets may include: one or more SSB resource sets, one or more TCI activated state sets, or one or more activated PL RS sets. In some aspects, the UL report includes the virtual PHR report that is based on one or more beam-specific PC parameters associated with the one or more candidate SSBRIs or the one or more candidate CRIs.

In some aspects, the one or more beam-specific PC parameters may include one or more of: the PL RS, a target received power, a close loop index, or a pathloss compensation factor. In some aspects, the UL report includes the virtual PHR report, and the virtual PHR report includes one or more beam specific MPE or P-MPR associated with the one or more candidate SSBRIs or the one or more candidate CRIs. In some aspects, the UL report includes the L1 CSI report, and the L1 CSI report includes K resource indices associated with the one or more UL metrics. K may be a positive integer. Each of the K resource indices may be associated with a SSB or a CSI RS associated with the one or more candidate SSBRIs or the one or more candidate CRIs. In some aspects, each of the K resource indices may be one to one mapped to the one or more UL metrics. The one or more UL metrics may include: a MPE, a UL RSRP, or the virtual PHR, the virtual PHR being based on a beam specific MPE, a beam specific P-MPR, or one or more beam specific PC parameters. In some aspects, the UL report further includes a maximum value for K supported by the UE. In some aspects, the UL report may include the L1 CSI report, the L1 CSI report including one of: an aperiodic CSI report, a semi-persistent CSI report, or a periodical CSI report, and the CSI report may be carried in PUCCH or PUSCH.

In some aspects, one or more measured SSB or CSI-RS associated with the one or more candidate SSBRIs or the one or more candidate CRIs is used as the PL RS. In some aspects, the PL RS is a default PL RS. In some aspects, the default PL RS is an SSB for reading a MIB. In some aspects, the one or more candidate SSBRIs or the one or more candidate CRIs may be associated with a joint or UL unified TCI. In some aspects, the PL RS is associated with the joint or UL TCI. In some aspects, the one or more candidate SSBRIs or the one or more candidate CRIs are associated with one or more PC parameters. In some aspects, the one or more PC parameters includes one or more of: the PL RS, a target received power, a close loop index, or a pathloss compensation factor. In some aspects, the one or more PC parameters includes a default set of PC parameters. In some aspects, the PL RS is a default PL RS, and the one or more PC parameters includes a default PC parameter associated with the default PL RS. In some aspects, the one or more candidate SSBRIs or the one or more candidate CRIs are associated with a joint or UL unified TCI, and the one or more PC parameters are associated with the joint or UL TCI.

At 704, the UE may communicate with the base station based on the uplink report. For example, the UE 602 may communicate with the base station 604 based on the uplink report. In some aspects, 704 may be performed by the communication component 942 of FIG. 9.

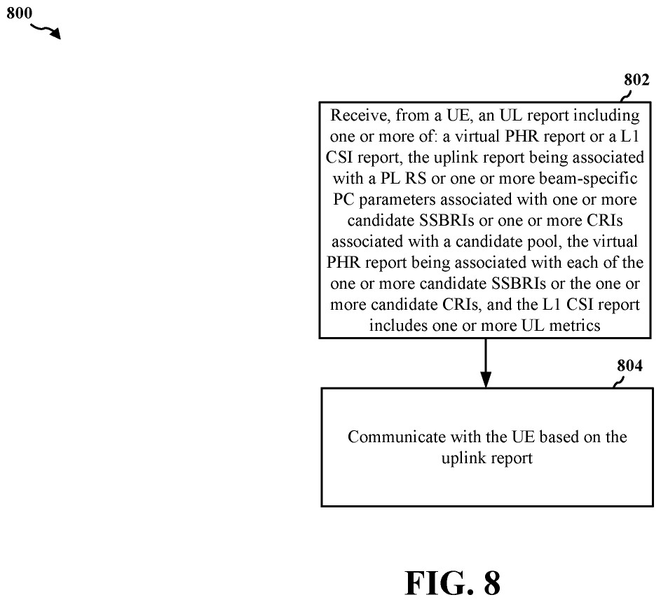

FIG. 8 is a flowchart 800 of a method of wireless communication. The method may be performed by a base station (e.g., the base station 102/180, the base station 402, the base station 604; the apparatus 1002). The method may be used for beam-specific UL reporting that may improve efficiency of wireless communication.

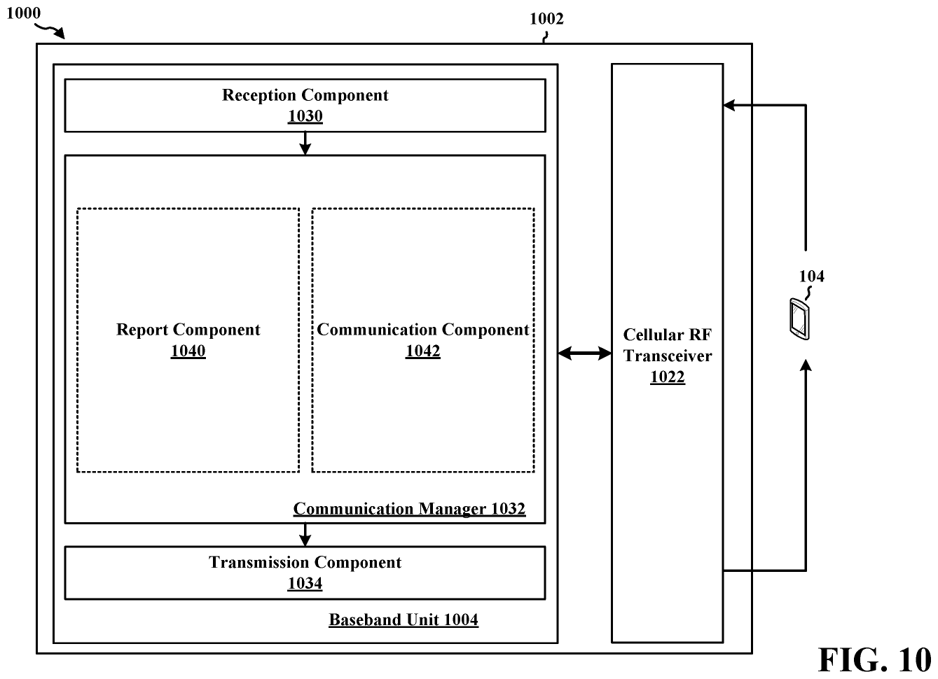

At 802, the base station may receive, from a UE, an UL report. The UL report may include one or more of: a virtual PHR report or a L1 CSI report. The uplink report may be associated with a PL RS or one or more PC parameters associated with one or more candidate SSBRIs or one or more CRIs associated with a candidate pool. The virtual PHR report may be associated with each of the one or more candidate SSBRIs or the one or more candidate CRIs, and the L1 CSI report may include one or more UL metrics. For example, the base station 804 may receive, from the UE 802, an UL report 606 including one or more of: a virtual PHR report or a L1 CSI report. In some aspects, 802 may be performed by the report component 1040 of FIG. 10. In some aspects, the UL report includes the virtual PHR report based on the candidate pool is configured via RRC. In some aspects, the one or more RS sets may include: one or more SSB resource sets, one or more TCI activated state sets, or one or more activated PL RS sets. In some aspects, the UL report includes the virtual PHR report that is based on one or more beam-specific PC parameters associated with the one or more candidate SSBRIs or the one or more candidate CRIs.

In some aspects, the one or more beam-specific PC parameters may include one or more of: the PL RS, a target received power, a close loop index, or a pathloss compensation factor. In some aspects, the UL report includes the virtual PHR report, and the virtual PHR report includes one or more beam specific MPE or P-MPR associated with the one or more candidate SSBRIs or the one or more candidate CRIs. In some aspects, the UL report includes the L1 CSI report, and the L1 CSI report includes K resource indices associated with the one or more UL metrics. K may be a positive integer. Each of the K resource indices may be associated with a SSB or a CSI RS associated with the one or more candidate SSBRIs or the one or more candidate CRIs. In some aspects, each of the K resource indices may be one to one mapped to the one or more UL metrics. The one or more UL metrics may include: a MPE, a UL RSRP, or the virtual PHR, the virtual PHR being based on a beam specific MPE, a beam specific P-MPR, or one or more beam specific PC parameters. In some aspects, the UL report further includes a maximum value for K supported by the UE. In some aspects, the UL report may include the L1 CSI report, the L1 CSI report including one of: an aperiodic CSI report, a semi-persistent CSI report, or a periodical CSI report, and the CSI report may be carried in PUCCH or PUSCH.

In some aspects, one or more measured SSB or CSI-RS associated with the one or more candidate SSBRIs or the one or more candidate CRIs is used as the PL RS. In some aspects, the PL RS is a default PL RS. In some aspects, the default PL RS is an SSB for reading a MIB. In some aspects, the one or more candidate SSBRIs or the one or more candidate CRIs may be associated with a joint or UL unified TCI. In some aspects, the PL RS is associated with the joint or UL TCI. In some aspects, the one or more candidate SSBRIs or the one or more candidate CRIs are associated with one or more PC parameters. In some aspects, the one or more PC parameters includes one or more of: the PL RS, a target received power, a close loop index, or a pathloss compensation factor. In some aspects, the one or more PC parameters includes a default set of PC parameters. In some aspects, the PL RS is a default PL RS, and the one or more PC parameters includes a default PC parameter associated with the default PL RS. In some aspects, the one or more candidate SSBRIs or the one or more candidate CRIs are associated with a joint or UL unified TCI, and the one or more PC parameters are associated with the joint or UL TCI.

At 804, the base station may communicate with the UE based on the uplink report. For example, the base station 604 may communicate with the UE 602 based on the uplink report. In some aspects, 804 may be performed by the communication component 1042 of FIG. 10.

FIG. 9 is a diagram 900 illustrating an example of a hardware implementation for an apparatus 902. The apparatus 902 may be a UE, a component of a UE, or may implement UE functionality. In some aspects, the apparatus 902 may include a cellular baseband processor 904 (also referred to as a modem) coupled to a cellular RF transceiver 922. In some aspects, the apparatus 902 may further include one or more subscriber identity modules (SIM) cards 920, an application processor 906 coupled to a secure digital (SD) card 908 and a screen 910, a Bluetooth module 912, a wireless local area network (WLAN) module 914, a Global Positioning System (GPS) module 916, or a power supply 918. The cellular baseband processor 904 communicates through the cellular RF transceiver 922 with the UE 104 and/or BS 102/180. The cellular baseband processor 904 may include a computer-readable medium/memory. The computer-readable medium/memory may be non-transitory. The cellular baseband processor 904 is responsible for general processing, including the execution of software stored on the computer-readable medium/memory. The software, when executed by the cellular baseband processor 904, causes the cellular baseband processor 904 to perform the various functions described supra. The computer-readable medium/memory may also be used for storing data that is manipulated by the cellular baseband processor 904 when executing software. The cellular baseband processor 904 further includes a reception component 930, a communication manager 932, and a transmission component 934. The communication manager 932 includes the one or more illustrated components. The components within the communication manager 932 may be stored in the computer-readable medium/memory and/or configured as hardware within the cellular baseband processor 904. The cellular baseband processor 904 may be a component of the UE 350 and may include the memory 360 and/or at least one of the TX processor 368, the RX processor 356, and the controller/processor 359. In one configuration, the apparatus 902 may be a modem chip and include just the cellular baseband processor 904, and in another configuration, the apparatus 902 may be the entire UE (e.g., see 350 of FIG. 3) and include the additional modules of the apparatus 902.

The communication manager 932 may include a report component 940 that is configured to transmit, to a base station, an UL report associated with a PL RS or one or more beam-specific PC parameters associated with one or more candidate SSBRIs or one or more CRIs associated with a candidate pool. The UL report may include one or more of: a virtual PHR report associated with each of the one or more candidate SSBRIs or the one or more candidate CRIs, or a L1 CSI report including one or more UL metrics, e.g., as described in connection with 702 in FIG. 7. The communication manager 932 may further include a communication component 942 that may be configured to communicate with the base station based on the uplink report, e.g., as described in connection with 704 in FIG. 7.

The apparatus may include additional components that perform each of the blocks of the algorithm in the flowchart of FIG. 7. As such, each block in the flowcharts of FIG. 7 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 902 may include a variety of components configured for various functions. In one configuration, the apparatus 902, and in particular the cellular baseband processor 904, may include means for transmitting, to a base station, an UL report associated with a PL RS or one or more beam-specific PC parameters associated with one or more candidate SSBRIs or one or more CRIs associated with a candidate pool; the UL report comprising one or more of: a virtual PHR report associated with each of the one or more candidate SSBRIs or the one or more candidate CRIs, or a L1 CSI report comprising one or more UL metrics. The cellular baseband processor 904 may further include means for communicating with the base station based on the uplink report. The means may be one or more of the components of the apparatus 902 configured to perform the functions recited by the means. As described supra, the apparatus 902 may include the TX Processor 368, the RX Processor 356, and the controller/processor 359. As such, in one configuration, the means may be the TX Processor 368, the RX Processor 356, and the controller/processor 359 configured to perform the functions recited by the means.

FIG. 10 is a diagram 1000 illustrating an example of a hardware implementation for an apparatus 1002. The apparatus 1002 may be a base station, a component of a base station, or may implement base station functionality. In some aspects, the apparatus 902 may include a baseband unit 1004. The baseband unit 1004 may communicate through a cellular RF transceiver 1022 with the UE 104. The baseband unit 1004 may include a computer-readable medium/memory. The baseband unit 1004 is responsible for general processing, including the execution of software stored on the computer-readable medium/memory. The software, when executed by the baseband unit 1004, causes the baseband unit 1004 to perform the various functions described supra. The computer-readable medium/memory may also be used for storing data that is manipulated by the baseband unit 1004 when executing software. The baseband unit 1004 further includes a reception component 1030, a communication manager 1032, and a transmission component 1034. The communication manager 1032 includes the one or more illustrated components. The components within the communication manager 1032 may be stored in the computer-readable medium/memory and/or configured as hardware within the baseband unit 1004. The baseband unit 1004 may be a component of the base station 310 and may include the memory 376 and/or at least one of the TX processor 316, the RX processor 370, and the controller/processor 375.

The communication manager 1032 may include a report component 1040 that may receive, from a UE, an UL report associated with a PL RS or one or more beam-specific PC parameters associated with one or more candidate SSBRIs or one or more CRIs associated with a candidate pool. The UL report may include one or more of: a virtual PHR report associated with each of the one or more candidate SSBRIs or the one or more candidate CRIs, or a L1 CSI report including one or more UL metrics, e.g., as described in connection with 802 in FIG. 8. The communication manager 1032 further may include a communication component 1042 that may communicate with the UE based on the uplink report, e.g., as described in connection with 804 in FIG. 8.

The apparatus may include additional components that perform each of the blocks of the algorithm in the flowchart of FIG. 8. As such, each block in the flowchart of FIG. 8 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1002 may include a variety of components configured for various functions. In one configuration, the apparatus 1002, and in particular the baseband unit 1004, may include means for an UL report associated with a PL RS or one or more beam-specific PC parameters associated with one or more candidate SSBRIs or one or more CRIs associated with a candidate pool; the UL report comprising one or more of: a virtual PHR report associated with each of the one or more candidate SSBRIs or the one or more candidate CRIs, or a L1 CSI report comprising one or more UL metrics. The baseband unit 1004 may further include means for communicating with the UE based on the UL report. The means may be one or more of the components of the apparatus 1002 configured to perform the functions recited by the means. As described supra, the apparatus 1002 may include the TX Processor 316, the RX Processor 370, and the controller/processor 375. As such, in one configuration, the means may be the TX Processor 316, the RX Processor 370, and the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication at a UE, comprising: a memory; and at least one processor coupled to the memory and configured to: transmit, to a base station, an UL report associated with a PL RS or one or more beam-specific PC parameters associated with one or more candidate SSBRIs or one or more CRIs associated with a candidate pool; the UL report comprising one or more of: a virtual PHR report associated with each of the one or more candidate SSBRIs or the one or more candidate CRIs, or a L1 CSI report comprising one or more UL metrics; and communicate with the base station based on the UL report.

Aspect 2 is the apparatus of aspect 1, wherein the UL report includes the virtual PHR report based on the candidate pool is configured via RRC.

Aspect 3 is the apparatus of any of aspects 1-2, wherein the UL report includes the virtual PHR report and the candidate pool is derived based on one or more RS sets.

Aspect 4 is the apparatus of any of aspects 1-3, wherein the one or more RS sets comprises: one or more SSB resource sets, one or more TCI activated state sets, or one or more activated PL RS sets.

Aspect 5 is the apparatus of any of aspects 1-4, wherein the UL report includes the virtual PHR report that is based on the one or more beam-specific PC parameters associated with the one or more candidate SSBRIs or the one or more candidate CRIs.

Aspect 6 is the apparatus of any of aspects 1-5, wherein the one or more beam-specific PC parameters comprises one or more of: the PL RS, a target received power, a closed-loop index, or a pathloss compensation factor.

Aspect 7 is the apparatus of any of aspects 1-6, wherein the UL report includes the virtual PHR report, and the virtual PHR report comprises one or more beam specific MPE or P-MPR associated with the one or more candidate SSBRIs or the one or more candidate CRIs.

Aspect 8 is the apparatus of any of aspects 1-7, wherein the UL report includes the L1 CSI report, and the L1 CSI report comprises K resource indices associated with the one or more UL metrics, K being a positive integer, each of the K resource indices being associated with a SSB or a CSI RS associated with the one or more candidate SSBRIs or the one or more candidate CRIs.

Aspect 9 is the apparatus of any of aspects 1-8, wherein each of the K resource indices is one to one mapped to the one or more UL metrics, and wherein the one or more UL metrics comprises: a MPE, a UL RSRP, or the virtual PHR, the virtual PHR being based on a beam specific MPE, a beam specific P-MPR, or the one or more beam specific PC parameters.

Aspect 10 is the apparatus of any of aspects 1-9, wherein the UL report further comprises a maximum value for K supported by the UE.

Aspect 11 is the apparatus of any of aspects 1-10, wherein the UL report includes the L1 CSI report, the L1 CSI report comprising one of: an aperiodic CSI report, a semi-persistent CSI report, or a periodical CSI report, and wherein the CSI report is carried in PUCCH or PUSCH.

Aspect 12 is the apparatus of any of aspects 1-11, wherein one or more measured SSB or CSI-RS associated with the one or more candidate SSBRIs or the one or more candidate CRIs is used as the PL RS.

Aspect 13 is the apparatus of any of aspects 1-12, wherein the PL RS is a default PL RS.

Aspect 14 is the apparatus of any of aspects 1-13, wherein the default PL RS is an SSB for reading a MIB.

Aspect 15 is the apparatus of any of aspects 1-14, wherein the one or more candidate SSBRIs or the one or more candidate CRIs are associated with a joint or UL unified TCI, and wherein the PL RS is associated with the joint or UL TCI.

Aspect 16 is the apparatus of any of aspects 1-15, wherein the one or more candidate SSBRIs or the one or more candidate CRIs are associated with the one or more PC parameters.

Aspect 17 is the apparatus of any of aspects 1-16, wherein the one or more PC parameters comprises one or more of: the PL RS, a target received power, a closed-loop index, or a pathloss compensation factor.

Aspect 18 is the apparatus of any of aspects 1-17, wherein the one or more PC parameters comprises a default set of PC parameters.

Aspect 19 is the apparatus of any of aspects 1-18, wherein the PL RS is a default PL RS, and wherein the one or more PC parameters comprises a default PC parameter associated with the default PL RS.

Aspect 20 is the apparatus of any of aspects 1-19, wherein the one or more candidate SSBRIs or the one or more candidate CRIs are associated with a joint or UL unified TCI, and wherein the one or more PC parameters are associated with the joint or UL TCI.

Aspect 21 is the apparatus of any of aspects 1-20, further comprising at least one antenna and a transceiver coupled to the at least one processor and the at least one antenna.

Aspect 22 is an apparatus for wireless communication at base station, comprising: a memory; and at least one processor coupled to the memory and configured to: receive, from a UE, an UL report associated with a PL RS or one or more beam-specific PC parameters associated with one or more candidate SSBRIs or one or more CRIs associated with a candidate pool; the UL report comprising one or more of: a virtual PHR report associated with each of the one or more candidate SSBRIs or the one or more candidate CRIs, or a L1 CSI report comprising one or more UL metrics; and communicate with the UE based on the UL report.

Aspect 23 is the apparatus of aspect 22, wherein the UL report includes the virtual PHR report based on the candidate pool is configured via RRC.

Aspect 24 is the apparatus of any of aspects 22-23, wherein the UL report includes the virtual PHR report and the candidate pool is derived based on one or more RS sets.

Aspect 25 is the apparatus of any of aspects 22-24, wherein the one or more RS sets comprises: one or more SSB resource sets, one or more TCI activated state sets, or one or more activated PL RS sets.

Aspect 26 is the apparatus of any of aspects 22-25, wherein the UL report includes the virtual PHR report that is based on the one or more beam-specific PC parameters associated with the one or more candidate SSBRIs or the one or more candidate CRIs.

Aspect 27 is the apparatus of any of aspects 22-26, wherein the one or more beam-specific PC parameters comprises one or more of: the PL RS, a target received power, a closed-loop index, or a pathloss compensation factor.

Aspect 28 is the apparatus of any of aspects 22-27, further comprising at least one antenna and a transceiver coupled to the at least one processor and the at least one antenna.

Aspect 29 is a method of wireless communication for implementing any of aspects 1 to 21.

Aspect 30 is an apparatus for wireless communication including means for implementing any of aspects 1 to 21.

Aspect 31 is a computer-readable medium storing computer executable code, where the code when executed by a processor causes the processor to implement any of aspects 22 to 28.

Aspect 32 is a method of wireless communication for implementing any of aspects 22 to 28.

Aspect 33 is an apparatus for wireless communication including means for implementing any of aspects 22 to 28.

Aspect 34 is a computer-readable medium storing computer executable code, where the code when executed by a processor causes the processor to implement any of aspects 22 to 28.

1-30. (canceled)

31. An apparatus for wireless communication at a user equipment (UE), comprising:
at least one memory; and
at least one processor coupled to the at least one memory and configured to:
transmit, to a base station, an uplink (UL) report associated with a pathloss (PL) reference signal (RS) or one or more beam-specific power control (PC) parameters associated with one or more candidate synchronization signal block (SSB) resource indicators (SSBRIs) or one or more channel state information (CSI) RS resource indicators (CRIs) associated with a candidate pool, the UL report comprising one or more of:
a virtual power headroom (PHR) report associated with each of the one or more candidate SSBRIs or the one or more candidate CRIs, or a layer 1 (L1) channel state information (CSI) report comprising one or more UL metrics; and
communicate with the base station based on the UL report.

32. The apparatus of claim 31, wherein the UL report includes the virtual PHR report based on the candidate pool is configured via radio resource control (RRC).

33. The apparatus of claim 31, wherein the UL report includes the virtual PHR report and the candidate pool is derived based on one or more RS sets.

34. The apparatus of claim 33, wherein the one or more RS sets comprises: one or more SSB resource sets, one or more transmission configuration indicator (TCI) activated state sets, or one or more activated PL RS sets.

35. The apparatus of claim 31, wherein the UL report includes the virtual PHR report that is based on the one or more beam-specific PC parameters associated with the one or more candidate SSBRIs or the one or more candidate CRIs, and wherein the one or more beam-specific power control (PC) parameters comprises one or more of: the PL RS, a target received power, a closed-loop index, or a pathloss compensation factor.

36. The apparatus of claim 31, wherein the UL report includes the virtual PHR report, and the virtual PHR report comprises one or more beam specific maximum permissible exposure (MPE) or power management maximum power reduction (P-MPR) associated with the one or more candidate SSBRIs or the one or more candidate CRIs.

37. The apparatus of claim 31, wherein the UL report includes the L1 CSI report, and the L1 CSI report comprises K resource indices associated with the one or more UL metrics, K being a positive integer, each of the K resource indices being associated with a SSB or a CSI RS associated with the one or more candidate SSBRIs or the one or more candidate CRIs.

38. The apparatus of claim 37, wherein each of the K resource indices is one to one mapped to the one or more UL metrics, and wherein the one or more UL metrics comprises: a maximum permissible exposure (MPE), a UL reference signal received power (RSRP), or the virtual PHR, the virtual PHR being based on a beam specific maximum permissible exposure (MPE), a beam specific power management maximum power reduction (P-MPR), or one or more beam specific PC parameters, and wherein the UL report further comprises a maximum value for K supported by the UE.

39. The apparatus of claim 31, wherein the UL report includes the L1 CSI report, the L1 CSI report comprising one of: an aperiodic CSI report, a semi-persistent CSI report, or a periodical CSI report, and wherein the CSI report is carried in physical uplink control channel (PUCCH) or physical uplink shared channel (PUSCH).

40. The apparatus of claim 31, wherein one or more measured SSB or CSI-RS associated with the one or more candidate SSBRIs or the one or more candidate CRIs is used as the PL RS.

41. The apparatus of claim 31, wherein the PL RS is a default PL RS, and wherein the default PL RS is an SSB for reading a master information block (MIB).

42. The apparatus of claim 31, wherein the one or more candidate SSBRIs or the one or more candidate CRIs are associated with a joint or UL unified transmission configuration indicator (TCI), and wherein the PL RS is associated with the joint or UL TCI.

43. The apparatus of claim 31, wherein the one or more candidate SSBRIs or the one or more candidate CRIs are associated with the one or more PC parameters, and wherein the one or more PC parameters comprises one or more of: the PL RS, a target received power, a closed-loop index, or a pathloss compensation factor.

44. The apparatus of claim 31, further comprising at least one antenna and at least one transceiver coupled to the at least one processor and the at least one antenna, and wherein the at least one transceiver and the at least one antenna are configured to communicate with the base station based on the UL report.

45. An apparatus for wireless communication at base station, comprising:
at least one memory; and
at least one processor coupled to the at least one memory and configured to:
receive, from a user equipment (UE), an uplink (UL) report associated with a pathloss (PL) reference signal (RS) or one or more beam-specific power control (PC) parameters associated with one or more candidate synchronization signal block (SSB) resource indicators (SSBRIs) or one or more channel state information (CSI) RS resource indicators (CRIs) associated with a candidate pool, the UL report comprising one or more of:
a virtual power headroom (PHR) report associated with each of the one or more candidate SSBRIs or the one or more candidate CRIs, or a layer 1 (L1) channel state information (CSI) report comprising one or more UL metrics; and
communicate with the UE based on the UL report.

46. The apparatus of claim 45, wherein the UL report includes the virtual PHR report based on the candidate pool is configured via radio resource control (RRC).

47. The apparatus of claim 45, wherein the UL report includes the virtual PHR report and the candidate pool is derived based on one or more RS sets.

48. The apparatus of claim 47, wherein the one or more RS sets comprises: one or more SSB resource sets, one or more transmission configuration indicator (TCI) activated state sets, or one or more activated PL RS sets.

49. The apparatus of claim 45, wherein the UL report includes the virtual PHR report that is based on the one or more beam-specific PC parameters associated with the one or more candidate SSBRIs or the one or more candidate CRIs, and wherein the one or more beam-specific power control (PC) parameters comprises one or more of: the PL RS, a target received power, a closed-loop index, or a pathloss compensation factor.

50. The apparatus of claim 45, wherein the UL report includes the virtual PHR report, and the virtual PHR report comprises one or more beam specific maximum permissible exposure (MPE) or power management maximum power reduction (P-MPR) associated with the one or more candidate SSBRIs or the one or more candidate CRIs.

51. The apparatus of claim 45, wherein the UL report includes the L1 CSI report, and the L1 CSI report comprises K resource indices associated with the one or more UL metrics, K being a positive integer, each of the K resource indices being associated with a SSB or a CSI RS associated with the one or more candidate SSBRIs or the one or more candidate CRIs.

52. The apparatus of claim 51, wherein each of the K resource indices is one to one mapped to the one or more UL metrics, and wherein the one or more UL metrics comprises: a maximum permissible exposure (MPE), a UL reference signal received power (RSRP), or the virtual PHR, the virtual PHR being based on a beam specific maximum permissible exposure (MPE), a beam specific power management maximum power reduction (P-MPR), or one or more beam specific PC parameters, and wherein the UL report further comprises a maximum value for K supported by the UE.

53. The apparatus of claim 45, wherein the UL report includes the L1 CSI report, the L1 CSI report comprising one of: an aperiodic CSI report, a semi-persistent CSI report, or a periodical CSI report, and wherein the CSI report is carried in physical uplink control channel (PUCCH) or physical uplink shared channel (PUSCH).

54. The apparatus of claim 45, wherein one or more measured SSB or CSI-RS associated with the one or more candidate SSBRIs or the one or more candidate CRIs is used as the PL RS.

55. The apparatus of claim 45, wherein the PL RS is a default PL RS, and wherein the default PL RS is an SSB for reading a master information block (MIB).

56. The apparatus of claim 45, wherein the one or more candidate SSBRIs or the one or more candidate CRIs are associated with a joint or UL unified transmission configuration indicator (TCI), and wherein the PL RS is associated with the joint or UL TCI.

57. The apparatus of claim 45, wherein the one or more candidate SSBRIs or the one or more candidate CRIs are associated with the one or more PC parameters, and wherein the one or more PC parameters comprises one or more of: the PL RS, a target received power, a closed-loop index, or a pathloss compensation factor.

58. The apparatus of claim 45, further comprising at least one antenna and at least one transceiver coupled to the at least one processor and the at least one antenna, and wherein the at least one transceiver and the at least one antenna are configured to communicate with the base station based on the UL report.

59. A method of wireless communication at a user equipment (UE), comprising:
transmitting, to a base station, an uplink (UL) report associated with a pathloss (PL) reference signal (RS) or one or more beam-specific power control (PC) parameters associated with one or more candidate synchronization signal block (SSB) resource indicators (SSBRIs) or one or more channel state information (CSI) RS resource indicators (CRIs) associated with a candidate pool, the UL report comprising one or more of:
a virtual power headroom (PHR) report associated with each of the one or more candidate SSBRIs or the one or more candidate CRIs, or a layer 1 (L1) channel state information (CSI) report comprising one or more UL metrics; and
communicating with the base station based on the UL report.

60. A method of wireless communication at a base station, comprising:
receiving, from a user equipment (UE), an uplink (UL) report associated with a pathloss (PL) reference signal (RS) or one or more beam-specific power control (PC) parameters associated with one or more candidate synchronization signal block (SSB) resource indicators (SSBRIs) or one or more channel state information (CSI) RS resource indicators (CRIs) associated with a candidate pool, the UL report comprising one or more of:
a virtual power headroom (PHR) report associated with each of the one or more candidate SSBRIs or the one or more candidate CRIs, or a layer 1 (L1) channel state information (CSI) report comprising one or more UL metrics; and
communicating with the UE based on the UL report.
